(19) United States
(12) Patent Application Publication
(10) Pub. No.: US 2025/0145469 A1
(43) Pub. Date: May 8, 2025

(54) ASPHALT-BASED HOLLOW ACTIVATED CARBON MICROSPHERE AND METHOD FOR PREPARING SAME, ELECTRODE SHEET, AND SUPERCAPACITOR

(71) Applicants: CHINA SHENHUA COAL TO LIQUID AND CHEMICAL CO., LTD, Beijing (CN); CHINA SHENHUA COAL TO LIQUID AND CHEMICAL SHANGHAI RESEARCH INSTITUTE, Shanghai (CN)

(72) Inventors: Lun ZHENG, Shanghai (CN); Fanwen XIN, Shanghai (CN); Ning XIANG, Shanghai (CN); Shansong GAO, Shanghai (CN); Geling YANG, Shanghai (CN); Geping SHU, Shanghai (CN); Hongxue WANG, Shanghai (CN); Shifu CHENG, Shanghai (CN)

(21) Appl. No.: 18/837,505

(22) PCT Filed: Feb. 10, 2023
(86) PCT No.: PCT/CN2023/075414

§ 371 Date: Aug. 9, 2024

(30) Foreign Application Priority Data
Feb. 15, 2022 (CN) 202210138748.2

(51) Int. Cl. C01B 32/318; C01B 32/354; H01G 11/44

(52) U.S. Cl. CPC C01B 32/318; C01B 32/382; H01G 11/44; C01P 2004/34; C01P 2004/61; C01P 2006/12; C01P 2006/14; C01P 2006/40

(57) ABSTRACT

The disclosure relates to the technical field of electrochemical energy storage material preparation, and discloses an asphalt-based hollow activated carbon microsphere and a preparation method thereof, an electrode sheet, and a supercapacitor. The preparation method of the asphalt-based hollow activated carbon microsphere comprises the following steps of: (1) mixing an asphalt of low ash content with a solvent to obtain a mixed asphalt solution; (2) subjecting the mixed asphalt solution to spray pyrolysis in an inert atmosphere to obtain a hollow carbon microsphere; (3) mixing the hollow carbon microsphere with an activating agent, and activating to obtain activated carbon; (4) subjecting the activated carbon to acid pickling and water washing to remove impurities, and drying to obtain the hollow activated carbon microsphere. The method has the features of simple process steps, low preparation cost, being suitable for continuous production and the like. The asphalt-based hollow activated carbon microsphere prepared by the method disclosed herein has a high specific surface area, a stable performance, environmental friendliness and an apparent hollow structure, and the supercapacitor prepared from the microsphere has a high specific capacitance and a high cycling capacity retention rate.

### CROSS-REFERENCE TO RELATED APPLICATIONS

This application is a U.S. National Stage of International Patent Application No. PCT/CN2023/075414 filed Feb. 10, 2023, which claims priority to Chinese Patent Application No. 202210138748.2 filed Feb. 15, 2022, both of which are incorporated by reference herein as if reproduced in their entireties.

### TECHNICAL FIELD

The present disclosure relates to the technical field of electrochemical energy storage material preparation, and particularly to an asphalt-based hollow activated carbon microsphere and a method for preparing same, an electrode sheet, and a supercapacitor.

### BACKGROUND

With the continuous consumption of fossil energy, not only a serious energy crisis is caused, but also a series of environmental problems are brought. Therefore, the development of new renewable energy sources such as solar energy and wind energy has become people's research focus, and an energy storage device, as a key component of the development, has also made considerable progress. Among many energy storage elements, a supercapacitor occupies a unique position in today's energy storage industry due to the features of short charging time, long service life, good temperature characteristics, energy saving and environmental protection.

Usually, the supercapacitor is composed of an electrode material, a diaphragm, an electrolyte and an outer shell. The electrode material, as a core component of the capacitor, plays a key role in performance. Carbon materials are widely used in electrode materials due to excellent ductility, high chemical stability and rich surface functional groups. Among many forms of carbon materials, hollow carbon microspheres not only have excellent conductivity and ultra-high specific surface area, but also can serve as a storage space for electrolyte ions due to their unique hollow structure, thus effectively shortening a transmission distance between the electrolyte ions and micropores, and showing a higher reversible specific capacitance.

At present, commonly used preparation methods of hollow carbon microspheres mainly comprise template method, suspension polymerization method, hydrothermal method, spray drying method and high-temperature pyrolysis method, wherein the spray method is regarded as the most promising technical method for industrial production due to the advantages of high speed, high efficiency, mass production and the like.

CN101541674A discloses a method for preparing a mesoporous carbon microsphere with a large specific surface area and a fine pore size, which comprises the following steps of: mixing a carbon precursor, a template agent and a solvent in advance, forming a precursor complex of the carbon microsphere through spray drying, then carbonizing at a high temperature, and finally removing the template to form an activated carbon microsphere. Although this method has a simple principle, pelletization and carbonization distribution increase the technological complexity, and the template agent needs to be removed later, especially for template agents such as certain metal oxides or SiO₂, the removal technology can increase environment and cost burdens. In addition, the prepared activated carbon has a low specific surface area (700 m²/g to 1300 m²/g), which cannot meet the requirements for the electrode material used in the supercapacitor.

CN109250716A discloses a preparation method of asphalt-based hollow spherical activated carbon, which comprises the following steps of: evenly mixing an asphalt of a low softening point (30° C. to 60° C.) and an asphalt of a high softening point (150° C. to 360° C.), adding into a spray granulator, drying at a preferred temperature of 100° C. to 220° C., and then preparing the asphalt-based hollow spherical activated carbon with a sphere diameter of 0.1 mm to 2.0 mm and a specific surface area of 1300 m²/g to 1600 m²/g by non-melting, carbonization and activation treatments. This method also has the problems of long non-melting treatment time, complicated technological steps and the like, and the viscosity of asphalt itself is high, so that even if the asphalt of the low softening point is added, certain challenges are still posed to the fluidity of the whole system, and it is difficult to ensure that the asphalt of the low softening point is completely volatilized during spraying to form sufficient pores.

CN106744783A discloses a preparation method of a graphitized hollow carbon microsphere, which comprises the following steps of: using an asphalt and an additive as raw materials, and preparing the graphitized hollow carbon microsphere by mixing, carbonization, acid pickling and other technologies, and the obtained carbon microsphere has a specific surface area of 100 m²/g to 1500 m²/g and an average particle size of 0.1 μm to 2 μm. Although the production technology of this method is not complicated, this method still belongs to the scope of preparing a hollow carbon sphere structure by a hard template, and the additive in a form of metal salts, such as metal salts of Fe, Mg, Ca and Zn, will be involved in the process, so that there are still the problems of template recycling and disposal, and metal impurity ions are prone to remain, which will limit the application of the carbon material, especially in the electrochemical field, the metal impurity ions have a great impact on the internal resistance of a material, thus directly affecting electrochemical properties of the material.

To sum up, although the hollow activated carbon microsphere has broad application prospects, there are still some problems, such as having a complicated preparation technology; needing to introduce the template agent; being easy to cause environmental pollution; and making prepared activated carbon have a low specific surface area, thus being unable to meet the requirements for the electrode material used in the supercapacitor.

### SUMMARY

The present disclosure aims to overcome the problems in the prior art, such as having a complicated hollow carbon microsphere preparation technology; needing to introduce a template agent; being easy to cause environmental pollution; and making prepared activated carbon have a low specific surface area, thus being unable to meet the requirements for an electrode material used in a supercapacitor, and to provide an asphalt-based hollow activated carbon microsphere and a preparation method thereof, an electrode sheet, and a supercapacitor, and the method has the features of simple process steps, low preparation cost, being suitable for continuous production and the like. The asphalt-based hollow activated carbon microsphere prepared by the method disclosed herein has a high specific surface area, a stable performance, environmental friendliness and an apparent hollow structure. When applied to a supercapacitor, the resulting capacitor will have a high specific capacitance and a high cycling capacity retention rate.

In order to achieve the above objects, the present disclosure provides a method for preparing an asphalt-based hollow activated carbon microsphere in a first aspect, which comprises the following steps of:
(1) mixing an asphalt of low ash content with a solvent to obtain a mixed asphalt solution;
(2) subjecting the mixed asphalt solution to spray pyrolysis in an inert atmosphere to obtain a hollow carbon microsphere;
(3) mixing the hollow carbon microsphere with an activating agent, and activating to obtain activated carbon;
(4) subjecting the activated carbon to acid pickling and water washing to remove impurities, and drying to obtain the hollow activated carbon microsphere.

The present disclosure provides an asphalt-based hollow activated carbon microsphere prepared by the method above in a second aspect. The asphalt-based hollow activated carbon microsphere has a particle size of 5 μm to 40 μm, a specific surface area of 1600 m²/g to 2450 m²/g, a pore volume of 1.8 m³/g to 3.2 m³/g.

The present disclosure provides an electrode sheet in a third aspect, which comprises the asphalt-based hollow activated carbon microsphere in the second aspect above.

The present disclosure provides a supercapacitor in a fourth aspect, which comprises the electrode sheet in the third aspect above.

Through the technical solutions above, the present disclosure can obtain the following beneficial effects.

(1) In the present disclosure, property differences between the solvent and the asphalt are utilized to prepare a hollow carbon microsphere with good sphericity and controllable particle size, and when applied in a supercapacitor, the hollow structure can provide a temporary storage space for an electrolyte, which effectively shortens a transmission distance between electrolyte ions and active sites, thus showing a higher reversible specific capacitance.

(2) In the prior art, hollow carbon microspheres are generally prepared by a hard (soft) template method, and silicon dioxide, a metal oxide, a silicate, and the like need to be added as a template agent in the process, which poses certain challenges to template processing and recycling. In the present disclosure, a self-template method is used to directly take the asphalt as a raw material, and the hollow structure is directly prepared by utilizing property differences between an asphalt solute and an organic solvent, so that steps of template introduction and removal are omitted, the production cost and the technological complexity are greatly reduced, and the problem of environmental pollution caused by the template removal in template methods is solved.

(3) The viscosity of asphalt is excessively large and long-time high-temperature heating is easy to cause coking to block a pipeline, there is a great test for the continuity of raw material transportation, and a mode of co-feeding the solvent and asphalt is adopted in the present disclosure, so that the hollow structure can be obtained on one hand, and the fluidity of asphalt can be improved on the other hand, and meanwhile, a softening temperature of the mixed solution is also reduced, so as to prevent the transportation pipeline from being blocked, thus being beneficial for long-term industrial operation.

(4) In the present disclosure, an asphalt can be directly carbonized and pelletized in one step, which solves the problems of energy consumption and sphere adhesion caused by long-term pre-oxidation and carbonization in traditional technologies, such as an emulsion method and a low-temperature spraying method, thus greatly improving production efficiency.

### BRIEF DESCRIPTION OF THE DRAWINGS

FIG. 1 is an SEM graph of a hollow carbon microsphere obtained in step (2) in Example 1.

FIG. 2 is a particle size distribution diagram of an asphalt-based hollow activated carbon microsphere prepared in Example 1.

### DETAILED DESCRIPTION

Endpoints of ranges and any values disclosed herein are not limited to the accurate ranges or values, and these ranges or values should be understood as comprising values close to these ranges or values. For numerical ranges, endpoint values of the ranges, the endpoint values of the ranges and individual point values, and the individual point values can be combined with each other to obtain one or more new numerical ranges, and these numerical ranges should be regarded as being specifically disclosed herein.

The present disclosure provides a method for preparing an asphalt-based hollow activated carbon microsphere in a first aspect, which comprises the following steps of:
(1) mixing an asphalt of low ash content with a solvent to obtain a mixed asphalt solution;
(2) subjecting the mixed asphalt solution to spray pyrolysis in an inert atmosphere to obtain a hollow carbon microsphere;
(3) mixing the hollow carbon microsphere with an activating agent, and activating to obtain activated carbon;
(4) subjecting the activated carbon to acid pickling and water washing to remove impurities, and drying to obtain the hollow activated carbon microsphere.

In the present disclosure, according to a combined action of property differences between an asphalt and a solvent and features of a spray pyrolysis process, the carbon microsphere with the hollow structure is prepared.

Inventors of the present disclosure found from researches that, when the mixed asphalt solution undergoes atomization in a high-temperature environment, the evaporation of the organic solvent causes a situation that a movement speed of the solvent on the surfaces of spherical droplets is faster than the diffusion speed of the asphalt, which leads to the increase of the concentration of asphalt on the surfaces of the droplets and occurrence of further solidification and carbonization, so as to obtain a hollow carbon microsphere with good sphericity and controllable particle size.

The preparation method of the asphalt-based hollow activated carbon microsphere provided by the present disclosure has the features of simple process steps, low preparation cost, being suitable for continuous production and the like.

In the present disclosure, conditions of the mixing in the step (1) are not specifically limited, as long as the conditions can facilitate the dissolution of the asphalt of low ash content. Preferably, the mixing is carried out under conditions comprising: a temperature of 90° C. to 300° C., heating time of 0.5 hours to 2 hours.

In some embodiments of the present disclosure, preferably, the asphalt of low ash content is selected from at least one of a coal-liquefied asphalt, a petroleum asphalt, a coal asphalt, a coal-coked asphalt, a synthetic asphalt and a natural asphalt. Preferably, the asphalt of low ash content has an ash content not greater than 1 wt %, a metal content less than 100 ppm by mass, a softening point less than 250° C.

In the present disclosure, the solvent is not specifically limited, as long as the solvent can dissolve the asphalt of low ash content. Preferably, the solvent is selected from at least one of a coking washing oil, quinoline, pyridine, toluene, xylene, carbon disulfide, tetrahydrofuran, carbon tetrachloride, a coal-liquefied light oil and a petroleum middle distillate.

In some embodiments of the present disclosure, preferably, a mass ratio of the asphalt of low ash content to the solvent is 1:1 to 5, preferably 1:1 to 2. When the above conditions are met, the asphalt-based hollow activated carbon microsphere prepared can have a high specific surface area, a stable performance and an apparent hollow structure; when applied in a supercapacitor, the specific capacitance and a cycling capacity retention rate of the capacitor can be significantly increased.

In some embodiments of the present disclosure, in the step (2), the spray pyrolysis is carried out under conditions comprising: a nozzle hole diameter of 0.5 mm to 2 mm, a nozzle feeding pressure of 0.1 MPa to 2.5 MPa, a spray pyrolysis temperature of 550° C. to 800° C., a discharge temperature of 550° C. to 700° C., material liquid retention time of 5 seconds to 15 seconds. It should be noted that, the greater proportion of asphalt in the mixed asphalt solution, the lower spray pyrolysis temperature, the greater nozzle hole diameter and the greater spraying pressure will all lead to a greater particle size and a thinner sphere wall of the hollow carbon microsphere prepared. The selection of different solvents has a great influence on the viscosity of the mixed asphalt solution, and also has a certain influence on the particle size at the same time, and specifically, corresponding adjustment may be carried out according to different practical application scenarios.

In the present disclosure, a process of the mixing in the step (3) is not specifically limited, as long as the process can ensure that the hollow carbon microsphere and the activating agent are evenly mixed. Preferably, the process of the mixing comprises: crushing and evenly mixing the hollow carbon microsphere and the activating agent by a pulverizer, wherein a rotating speed of the pulverizer is 5000 r/min to 25000 r/min.

In some embodiments of the present disclosure, preferably, a mass ratio of the hollow carbon microsphere to the activating agent is 1:0.5 to 4, preferably 1:1 to 3.

In some embodiments of the present disclosure, preferably, the activating agent is selected from at least one of an oxide containing potassium, a potassium salt, KOH, an alkaline-earth metal salt and an alkaline-earth metal oxide, H₃PO₄ and ZnCl₂, preferably at least one of KOH, K₂CO₃, KHCO₃, KCl and KMnO₄.

In some embodiments of the present disclosure, preferably, the activating is carried out under conditions comprising: an activation temperature of 600° C. to 900° C., preferably 700° C. to 800° C.; activation time of 0.5 hours to 2.5 hours; a heating rate of 1° C./min to 10° C./min; the activating is carried out in an inert atmosphere, preferably nitrogen or argon.

In some embodiments of the present disclosure, the activating may be carried out by direct heating or staged heating. Preferably, the staged heating is adopted, and specifically, the staged heating refers to heating from room temperature to 500° C., which is kept for 0.5 hours to 1 hour, and then heating to the activation temperature of 600° C. to 900° C., preferably 700° C. to 800° C., wherein a heating rate is 1° C./min to 10° C./min.

Inventors of the present disclosure found from researches that, redundant crystal water in the activating agent can be pre-removed by a staged heat preservation method, so that an activation effect is more obvious, thus achieving the purpose of reducing a dosage of the activating agent, and the asphalt-based hollow activated carbon microsphere prepared has a more stable performance.

In some embodiments of the present disclosure, in the step (4), the acid is selected from at least one of a hydrochloric acid, a nitric acid and a sulfuric acid, preferably a hydrochloric acid. The acid has a concentration of 0.5 mol/L to 3 mol/L, preferably 1 mol/L.

In the present disclosure, conditions of the drying in the step (4) are not specifically limited, and preferably, the drying is carried out under conditions comprising: a temperature of 80° C. to 120° C., drying time of 6 hours to 12 hours.

The present disclosure provides an asphalt-based hollow activated carbon microsphere prepared by the method above in a second aspect. The asphalt-based hollow activated carbon microsphere has a particle size of 5 μm to 40 μm, a specific surface area of 1600 m²/g to 2450 m²/g, a pore volume of 1.8 m³/g to 3.2 m³/g. The hollow activated carbon microsphere prepared by the method disclosed herein has a high specific surface area, a stable performance, environmental friendliness and an apparent hollow structure.

The present disclosure provides an electrode sheet in a third aspect, which comprises the asphalt-based hollow activated carbon microsphere in the second aspect above.

The present disclosure provides a supercapacitor in a fourth aspect, which comprises the electrode sheet in the third aspect above. The supercapacitor provided by the present disclosure has a high specific capacitance and a high cycling capacity retention rate.

The present disclosure will be described in detail hereinafter with reference to the examples. Raw materials involved in the following examples and comparative examples are all commercially available, unless otherwise specified.

A specific surface area and porosity analyzer with a model of Micromeritics ASAP2020 is used to conduct an adsorption and desorption test of a prepared sample to acquire a pore structure thereof, with a specific operation process as follows: the sample is degassed for 12 hours first, a degassing temperature is controlled at 300° C., and then a low-temperature adsorption and desorption test is carried out by program control. A specific surface area of the material is calculated by a Brunauer-Emmett-Teller (BET) model, and a pore volume of the material is calculated by a density functional theory (DFT).

A morphology of the sample is characterized by a scanning electron microscope (SEM) with a model of HITACHI FlexSEM1000 II.

Particle size distribution of the prepared sample is tested by a particle size analyzer with a model of Malvern MS2000.

### Example 1

### Preparation of Asphalt-Based Hollow Activated Carbon Microsphere:

(1) 1 kg of asphalt of low ash content and 1.5 kg of washing oil were respectively added into a stirring kettle to prepare a mixed asphalt solution with a mass ratio of 1:1.5, and the mixed asphalt solution was heated to 180° C. (which was namely a “mixing temperature”) and stirred at a constant temperature for 0.5 hour. A stirring speed was 100 r/min; a heating rate was 5° C./min; the asphalt used was obtained by extraction and separation process of direct coal liquefaction residues (which was namely a “coal-liquefied asphalt”) from China Shenhua Coal To Liquid and Chemical Co., Ltd., with an ash content less than 0.1 wt % and a softening point of 170° C.; the washing oil used was a conventional coking washing oil, with a density of 1.056 g/cm³.

(2) The above mixed asphalt solution at 180° C. was sprayed into a spray tower at 750° C. in a nitrogen atmosphere through a nozzle with a diameter of 1 mm at a pressure of 0.1 MPa (which was namely a “nozzle feeding pressure”) for a high-temperature pyrolysis reaction to form hollow carbon microspheres, then a solid product was collected by a high-temperature bag dust collector and naturally cooled to room temperature, and excess oil gas was emptied. A pipeline between the nozzle and the stirring kettle was kept at 180° C., a nitrogen temperature (or a spray pyrolysis temperature) was 750° C., a pressure was 0.08 MPa, a discharge temperature was 550° C., material liquid retention time was 7 seconds.

(3) 5 g of the above hollow carbon microspheres and 10 g of KOH (an activating agent) were crushed and evenly mixed by a high-speed universal pulverizer, placed in a tubular furnace protected by nitrogen at 800° C. to be calcined at a constant temperature for 2 hours, and naturally cooled to room temperature to obtain activated carbon microspheres. A rotating speed of the pulverizer was 24000 r/min, and the crushing lasted for 10 seconds; the tubular furnace was heated in stages: from room temperature to 500° C. at a heating rate of 10° C./min, wherein the temperature of 500° C. was kept for 1 hour; from 500° C. to 800° C. at a heating rate of 5° C./min, wherein the temperature of 800° C. (which was namely an “activation temperature”) was kept for 2 hours (which was namely “activation time”).

(4) The above activated carbon microspheres were placed in a beaker, dropwise added with 200 mL of hydrochloric acid solution with a concentration of 1 mol/L, fully stirred to react for 15 minutes, and then filtered, and the above operation was repeated twice; and then filter residues obtained by acid pickling were added with sufficient deionized water, fully stirred for 15 minutes, and then filtered, and the operation was repeated for 3 times to 5 times, until a pH value of a filtrate was ≈7, so as to obtain filter residues. Further, the filter residues were dried in a blast drying oven at 80° C. for 12 hours to obtain asphalt-based hollow activated carbon microspheres.

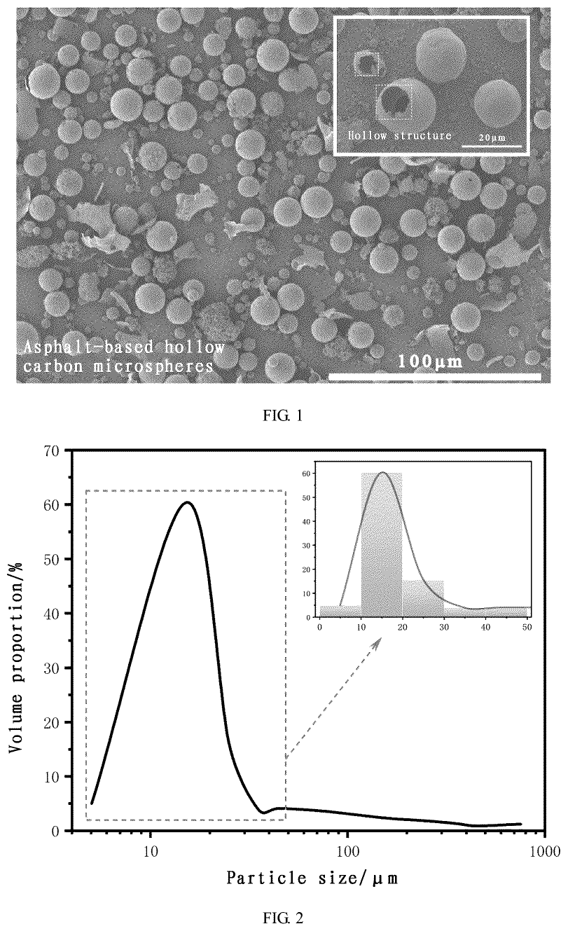

An SEM test was carried out on the hollow carbon microspheres obtained in the step (2). FIG. 1 was an SEM graph of the hollow carbon microsphere, and it could be seen from FIG. 1 that, the hollow carbon microsphere had an apparent hollow structure.

A pore structure of the prepared asphalt-based hollow activated carbon microsphere was tested, and test results were shown in Table 1.

A particle size of the prepared asphalt-based hollow activated carbon microsphere was tested. FIG. 2 was a particle size distribution diagram of the prepared asphalt-based hollow activated carbon microsphere, and it could be seen from FIG. 2 that, the particle size of the asphalt-based hollow activated carbon microsphere was 10 μm to 20 μm.

### Preparation of Electrode Sheet:

The prepared asphalt-based hollow activated carbon microsphere above, acetylene black and polytetrafluoroethylene (PTFE) (15 wt %) were evenly mixed in ethanol according to a mass ratio of 8:1:1, the mixture was rolled into a thin sheet with an even thickness by a roller, the thin sheet was placed in an oven to dry at 80° C. for 12 hours, the dried thin sheet was cut into a round sheet by a sheet cutter, and then the round sheet was pressed on nickel foam by a press machine to obtain the electrode sheet.

### Assembly and Electrochemical Performance Test of Supercapacitor:

Three-electrode test: the above electrode sheet was placed in a three-port electrolytic cell, a 6 M KOH solution was used as an electrolyte, a platinum electrode was used as a counter electrode, a Hg/HgO electrode was used as a reference electrode, a charge and discharge test was carried out by a Nova Autolab electrochemical workstation of Metrohm, with a voltage range of 0 to 1 V, a current density of 1 A/g, a test temperature of 25° C., the electrochemical test results were shown in Table 1.

Two-electrode test: the above electrode sheet was assembled into a button battery in a form of battery case-electrode sheet-diaphragm (polypropylene)-6 M KOH-electrode sheet-battery case, then a rate and a long-cycle performance of the button battery were tested by a Wuhan Land Battery Test System, with a voltage range of 0 to 1 V, a current density of 1 A/g, a long-cycle charge and discharge frequency of 10000 times, a test temperature of 25° C., the electrochemical test results were shown in Table 1.

### Examples 2 to 12 and Comparative Examples 1 to 3

Asphalt-based hollow activated carbon microspheres were prepared by the method of Example 1, except that parameters shown in Table 1 were adjusted.

Pore structures and particle sizes of the prepared asphalt-based hollow activated carbon microspheres were tested, and test results were shown in Table 1.

Electrode sheets were prepared by the method of Example 1, assembly and electrochemical performance tests of supercapacitors were carried out according to Example 1, and test results were shown in Table 1.

TABLE 1

| | | | | | Three- | Two- | Long |
|---|---|---|---|---|---|---|---|
| | | | Specific | | electrode | electrode | cycling |
| | | Particle | surface | Pore | specific | specific | capacity |
| | | size | area | volume | capacitance | capacitance | retention |
| | Parameters | (μm) | (m²/g) | (cm³/g) | (F/g) | (F/g) | rate (%) |
| Example 1 | — | 10-20 | 2453 | 3.06 | 273 | 229 | 95 |
| Example 2 | Nozzle hole diameter | 5-20 | 1872 | 2.25 | 238 | 210 | 94 |
| | of 0.5 mm | | | | | | |
| Example 3 | Nozzle feeding | 5-20 | 1769 | 1.93 | 241 | 209 | 94 |
| | pressure of 0.3 MPa | | | | | | |
| Example 4 | Spray pyrolysis | 10-30 | 2112 | 2.19 | 240 | 201 | 95 |
| | temperature of 600° C. | | | | | | |
| Example 5 | Petroleum asphalt | 5-30 | 2071 | 2.20 | 220 | 178 | 91 |
| | replacing coal-liquefied | | | | | | |
| | asphalt, mixing | | | | | | |
| | temperature in step | | | | | | |
| | (1) of 150° C. | | | | | | |
| Example 6 | Quinoline replacing | 10-30 | 1982 | 1.98 | 249 | 190 | 88 |
| | washing oil, mixing | | | | | | |
| | temperature in step | | | | | | |
| | (1) of 100° C. | | | | | | |
| Example 7 | Activating agent of | 10-20 | 2328 | 3.19 | 268 | 230 | 94 |
| | KMnO₄ | | | | | | |
| Example 8 | Mass ratio of hollow | 10-20 | 2213 | 3.10 | 262 | 210 | 95 |
| | carbon microsphere to | | | | | | |
| | KOH in step (3) of 1:3 | | | | | | |
| Example 9 | Activation temperature | 10-20 | 2190 | 2.41 | 238 | 204 | 94 |
| | of 700° C. | | | | | | |
| Example 10 | Activation time of 1 | 10-20 | 2037 | 1.89 | 233 | 198 | 93 |
| | hour | | | | | | |
| Example 11 | Direct heating to 800° | 10-20 | 2267 | 2.32 | 247 | 226 | 91 |
| | C. during activation | | | | | | |
| Example 12 | Mass ratio of asphalt to | 5-15 | 1698 | 2.84 | 237 | 169 | 82 |
| | washing oil of 1:2.5 | | | | | | |
| Comparative | Mass ratio of asphalt to | 2-10 | 1613 | 1.32 | 166 | 91 | 92 |
| Example 1 | washing oil of 1:8 | | | | | | |
| Comparative | Spray pyrolysis | 20-40 | 1573 | 1.29 | 161 | 97 | 81 |
| Example 2 | temperature of 400° C. | | | | | | |
| Comparative | Nozzle feeding pressure | 30-50 | 1714 | 1.48 | 173 | 92 | 89 |
| Example 3 | of 0.02 MPa | | | | | | |

It could be seen from the results in Table 1 that, the asphalt-based hollow activated carbon microspheres prepared by the method disclosed herein had a particle size of 5 μm to 40 μm, a specific surface area of 1600 m²/g to 2450 m²/g, a pore volume of 1.8 m³/g to 3.2 m³/g. Specific surface areas and pore volumes of the asphalt-based hollow activated carbon microspheres in Examples 1 to 12 were obviously higher than those in Comparative Examples 1 to 3. When the asphalt-based hollow activated carbon microspheres prepared by the present disclosure were used in the supercapacitors, specific capacitances of the supercapacitors were obviously higher than that of the comparative examples.

To sum up, the asphalt-based hollow activated carbon microspheres prepared by the technical solution of the present disclosure has a large specific surface area, a uniform particle size and a stable performance. Moreover, the preparation method has the features of simple process steps, low preparation cost, being suitable for continuous production and the like. When the prepared asphalt-based hollow activated carbon microsphere is used in the supercapacitor, the supercapacitor has a high specific capacitance and a high cycling capacity retention rate.

Those described above are preferred embodiments of the present disclosure, but are not intended to limit the present disclosure. Within the scope of the technical concept of the present disclosure, many simple modifications can be made to the technical solutions of the present disclosure, comprising the combination of various technical features in any other suitable way. These simple modifications and combinations shall also be regarded as the contents disclosed by the present disclosure and belong to the protection scope of the present disclosure.

1. A method for preparing an asphalt-based hollow activated carbon microsphere, comprising the following steps of:
(1) mixing an asphalt of low ash content with a solvent to obtain a mixed asphalt solution;
(2) subjecting the mixed asphalt solution to spray pyrolysis in an inert atmosphere to obtain a hollow carbon microsphere;
(3) mixing the hollow carbon microsphere with an activating agent, and activating to obtain activated carbon; and
(4) subjecting the activated carbon to acid pickling and water washing to remove impurities, and drying to obtain a hollow activated carbon microsphere.

2. The method according to claim 1, wherein, in the step (1), the mixing is carried out under conditions comprising: a temperature of 90° C. to 300° C., heating time of 0.5 hours to 2 hours;
wherein, the asphalt of low ash content is selected from at least one of a coal-liquefied asphalt, a petroleum asphalt, a coal asphalt, a coal-coked asphalt, a synthetic asphalt and a natural asphalt;
wherein, the asphalt of low ash content has an ash content not greater than 1 wt %, a metal content less than 100 ppm by mass, a softening point less than 250° C.;
wherein, the solvent is selected from at least one of a coking washing oil, quinoline, pyridine, toluene, xylene, carbon disulfide, tetrahydrofuran, carbon tetrachloride, a coal-liquefied light oil and a petroleum middle distillate; and
wherein, a mass ratio of the asphalt of low ash content to the solvent is 1:1 to 5, preferably 1:1 to 2.

3. The method according to claim 1, wherein, in the step (2), the spray pyrolysis is carried out under conditions comprising a nozzle hole diameter of 0.5 mm to 2 mm, a nozzle feeding pressure of 0.1 MPa to 2.5 MPa, a spray pyrolysis temperature of 550° C. to 800° C., a discharge temperature of 550° C. to 700° C.

4. The method according to claim 1, wherein:
a mass ratio of the hollow carbon microsphere to the activating agent is 1:0.5 to 4, preferably 1:1 to 3; and
the activating agent is selected from at least one of an oxide containing potassium, a potassium salt, KOH, an alkaline-earth metal salt and an alkaline-earth metal oxide, H₃PO₄ and ZnCl₂, preferably at least one of KOH, K₂CO₃, KHCO₃, KCl, and KMnO₄.

5. The method according to claim 1, wherein, in the step (3), the activating is carried out under conditions comprising an activation temperature of 600° C. to 900° C., preferably 700° C. to 800° C.; activation time of 0.5 hours to 2.5 hours; a heating rate of 1° C./min to 10° C./min; and the activating is carried out in an inert atmosphere, preferably nitrogen or argon.

6. The method according to claim 1, wherein:
in the step (4), the acid is selected from at least one of a hydrochloric acid, a nitric acid and a sulfuric acid, preferably a hydrochloric acid;
the acid has a concentration of 0.5 mol/L to 3 mol/L; and
the drying is carried out under conditions comprising a temperature of 80° C. to 120° C., time of 6 hours to 12 hours.

7. (canceled)

8. The method according to claim 1, wherein the asphalt-based hollow activated carbon microsphere has a particle size of 5 μm to 40 μm, a specific surface area of 1600 m²/g to 2450 m²/g, and a pore volume of 1.8 m³/g to 3.2 m³/g.

9. An electrode sheet, comprising the asphalt-based hollow activated carbon microsphere prepared by the method according to claim 1.

10. A supercapacitor, comprising the electrode sheet according to claim 9.

11. The supercapacitor according to claim 10, wherein the supercapacitor has a specific capacitance of 170 F/g to 270 F/g.
